(19) United States
(12) Patent Application Publication
(10) Pub. No.: US 2007/0148554 A1
(43) Pub. Date: Jun. 28, 2007

(54) Non-aqueous electrolytic solution and lithium secondary battery

(75) Inventor: Koji Abe, Yamaguchi (JP)

Correspondence Address: NIXON PEABODY, LLP, 401 9TH STREET, NW, SUITE 900, WASHINGTON, DC, 20004-2128, US

(73) Assignee: UBE INDUSTRIES, LTD., Ube-shi, Yamaguchi (JP)

(21) Appl. No.: 10/588,063

(22) PCT Filed: Feb. 1, 2005
(86) PCT No.: PCT/JP05/01424

§ 371 Date: Aug. 1, 2006

(30) Foreign Application Priority Data
Feb. 2, 2004 (JP) 2004-025834

(51) Int. Cl. H01M 10/40

(52) U.S. Cl. 429/330; 429/200; 429/331

(57) ABSTRACT

The present invention provides a lithium secondary battery improved in safety from overcharge as well as cycle characteristics. A non-aqueous electrolytic solution is used for the lithium secondary battery. In the non-aqueous electrolytic solution, an electrolyte salt is dissolved in a non-aqueous solvent. The non-aqueous solvent comprises two or more cyclic carbonate compounds. The non-aqueous electrolytic solution further contains 1 to 10 wt. % of a cyclohexylbenzene compound having a halogenated benzene ring and 0.1 to 5 wt. % of a fluorobenzene compound.

### FIELD OF THE INVENTION

The present invention relates to a non-aqueous electrolytic solution used in preparation of a lithium secondary battery excellent in battery performance. In more detail, the battery is improved in protection from overcharge, and gas generation from decomposition is inhibited while repeatedly employing the battery or storing it at an elevated temperature. The invention also relates to a lithium secondary battery using the non-aqueous electrolytic solution.

### BACKGROUND OF THE INVENTION

The lithium secondary battery has recently been widely used, for example, as an electric source for driving small-sized electronic devices. The lithium secondary battery comprises a positive electrode, a negative electrode and a non-aqueous electrolytic solution. The positive electrode generally comprises a complex oxide of lithium such as LiCoO₂, and the negative electrode generally comprises a carbonaceous material or metallic lithium. A carbonate such as ethylene carbonate (EC) and dimethyl carbonate (DMC) has preferably been used in the non-aqueous electrolytic solution for the lithium secondary battery.

The recent secondary battery is required to give a high voltage and a high energy density. It is difficult, however, to improve both the battery performances and the safety in an electrolytic solution of a conventional composition simultaneously. A battery of a high energy density working at a maximum voltage of higher than 4.2 V should particularly show high protection from overcharge, compared with the conventional battery. It is also difficult to maintain the cycle characteristics and the storage stability at high temperatures. Further, the battery often generates a gas, which may expand the battery. In consideration of the recent requirements on the lithium secondary battery, the performances of the battery so far developed do not satisfy the requirements. Therefore, the lithium secondary battery should be further improved in safety while keeping the battery performances to satisfy future requirements for the lithium secondary battery having a higher energy density.

An addition of a small amount of an organic compound has been known as for improving protection from overcharge in the non-aqueous secondary battery. For example, Japanese Patent Provisional Publication No. 2003-317803 discloses an electrolytic solution in which a compound formed by replacing at least one hydrogen atom of a benzene ring of cyclohexylbenzene with fluorine is added to a non-aqueous electrolytic solvent containing two or more cyclic carbonate compounds. Further, Japanese Patent Provisional Publication No. 10-112335 discloses an electrolytic solution in which a fluorobenzene compound is added to a non-aqueous electrolytic solvent containing a cyclic carbonate compound.

### DISCLOSURE OF THE INVENTION

### Problems to be Solved by the Invention

An object of the present invention is to solve the problem about the non-aqueous electrolytic solution for the lithium secondary battery. Another object of the invention is to improve protection from overcharge in a non-aqueous secondary battery of a high voltage and the high energy density. A further object of the invention is to provide a non-aqueous electrolytic solution for the lithium secondary battery, which can keep the cyclic characteristics or storage characteristics at a high temperature, and is prevented from expansion caused with gas generation. A furthermore object of the invention is to provide a lithium secondary battery using the non-aqueous electrolytic solution.

### Invention to Solve the Problem

The present invention resides in a non-aqueous electrolytic solution for a lithium secondary battery comprising an electrolyte in a non-aqueous solvent, wherein the non-aqueous solvent comprises two or more cyclic carbonate compounds, and wherein the non-aqueous electrolytic solution further contains 1 to 10 wt. % of a cyclohexylbenzene compound having a halogenated benzene ring and 0.1 to 5 wt. % of a fluorobenzene compound.

The invention also resides in a lithium secondary battery comprising a positive electrode, a negative electrode and a non-aqueous electrolytic solution, wherein the non-aqueous electrolytic solution is the non-aqueous electrolytic solution of the present invention defined above. The lithium secondary battery of the invention is favorably used in working the lithium secondary battery at a maximum working voltage of higher than 4.2 V.

In the present invention, the cyclohexylbenzene compound having a halogenated benzene ring is represented by the formula (I): 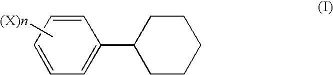
in which X is a halogen atom, and n is 1 or 2. There is no specific limitation with respect to the position of the substitution.

### Effect of the Invention

The present invention can provide a lithium secondary battery that is improved in protection from overcharge as well as cyclic characteristics or storage characteristics at a high temperature, and is prevented from expansion caused with gas generation. The lithium secondary battery of the invention is advantageously used in working the lithium secondary battery at a maximum working voltage of higher than 4.2 V (more advantageously higher than 4.25 V, and most advantageously higher than 4.3 V).

### BEST MODE FOR CARRYING OUT THE INVENTION

The present invention uses a cyclohexylbenzene compound having a halogenated benzene ring. Examples of the compounds include 1-fluoro-2-cyclohexylbenzene, 1-fluoro-3-cyclohexylbenzene, 1-fluoro-4-cyclohexylbenzene, 1-chloro-4-cyclohexylbenzene, 1-bromo-4-cyclohexylbenzene, 1-iodo-4-cyclohexylbenzene, 1,2-dichloro-3-cyclohexylbenzene, 1,3-dibromo-4-cyclohexylbenzene, 1,4-dichloro-2-cyclohexylbenzene, 1,2-difluoro-4-cyclohexylbenzene, and 1,3-difluoro-5-cyclohexylbenzene. Particularly preferred are 1-fluoro-2-cyclohexylbenzene, 1-fluoro-3-cyclohexylbenzene, and 1-fluoro-4-cyclohexylbenzene.

An excessive amount of the cyclohexylbenzene compound having the halogenated benzene ring might lower. battery performances. On the other hand, when the amount of the compound is too small, satisfactory battery performances might not be provided. Therefore, the amount of the cyclohexylbenzene compound having a halogenated benzene ring preferably is 1 wt. % or more, more preferably is 1.5 wt. % or more, and most preferably is 2 wt. % or more, based on the weight of the non-aqueous electrolytic solution. Further, the amount of the cyclohexylbenzene compound having the halogenated benzene ring preferably is 10 wt. % or less, more preferably is 7 wt. % or less, and most preferably is 5 wt. % or less, based on the weight of the non-aqueous electrolytic solution.

The fluorobenzene compound preferably is a compound having a fluorinated benzene ring. Examples of the benzene rings include benzene, biphenyl, diphenyl ether, and anisole. Particularly preferred are fluorinated benzene and fluorinated anisole.

The present invention uses the fluorobenzene compound. The examples of the fluorobenzene compound used in the present invention include fluorobenzene, difluorobenzene, trifluorobenzene, 2-fluorobiphenyl, 4-fluorobiphenyl, 2-fluorodiphenyl ether, 4-fluorodiphenyl ether, 2-fluoroanisole, 4-fluoroanisole, 2,4-difluoroanisole, 2,5-difluoroanisole, and 2,6-difluoroanisole. Particularly preferred are fluorobenzene, 1,2-difluorobenzene, and 2,4-difluoroanisole.

An excessive amount of the fluorobenzene compound might lower battery performances. On the other hand, when the amount of the compound is too small, satisfactory battery performances might not be provided. Therefore, the amount of the fluorobenzene compound preferably is 0.1 wt. % or more, more preferably is 0.5 wt. % or more, and most preferably is 1 wt. % or more, based on the weight of the non-aqueous electrolytic solution. Further, the amount of the fluorobenzene compound preferably is 5 wt. % or less, more preferably is 4 wt. % or less, and most preferably is 3 wt. % or less, based on the weight of the non-aqueous electrolytic solution.

The weight ratio of the fluorobenzene compound to the cyclohexylbenzene compound having the halogenated benzene ring preferably is not less than 0.1, more preferably is not less than 0.15, and most preferably is not less than 0.2. In the non-aqueous electrolytic solution, the weight ratio of the cyclohexylbenzene compound having the halogenated benzene ring to the fluorobenzene compound preferably is not more than 1.0, more preferably is not more than 0.8, and most preferably is not more than 0.5.

The non-aqueous electrolytic solution contains two or more cyclic carbonate compounds. The cyclic carbonate compounds preferably comprise at least two compounds selected from the group consisting of ethylene carbonate (EC), propylene carbonate (PC), butylene carbonate (BC), vinylene carbonate (VC), dimethylvinylene carbonate (DMVC), vinylethylene carbonate (VEC), and fluoroethylene carbonate (FEC). The cyclic carbonate compounds more preferably comprise at least two compounds selected from the group consisting of ethylene carbonate, propylene carbonate, vinylene carbonate, vinylethylene carbonate, and fluoroethylene carbonate. The cyclic carbonate compounds most preferably comprise at least two compounds selected from the group consisting of ethylene carbonate, vinylene carbonate, and fluoroethylene carbonate. One of the cyclic carbonate compounds is preferably selected from the group consisting of ethylene carbonate, propylene carbonate and butylene carbonate, and another is preferably selected from the group consisting of vinylene carbonate, dimethylvinylene carbonate, vinylethylene carbonate and fluoroethylene carbonate.

In the present invention, the non-aqueous electrolytic solution preferably further contains a linear carbonate compound. Examples of the linear-carbonate compounds preferably contained in the non-aqueous electrolytic solution include linear carbonates having an alkyl group, such as dimethyl carbonate (DMC), methyl ethyl carbonate (MEC), diethyl carbonate (DEC), methyl propyl carbonate (MPC), dipropyl carbonate (DPC), methyl butyl carbonate (MBC) and dibutyl carbonate (DBC). The alkyl group can have a straight or branched chain structure.

The proportion of the cyclic carbonate compound and the linear carbonate compound in the non-aqueous solvent preferably is in the range of 20:80 to 40:60 in terms of a volume ratio. When the electrolytic solution comprises the cyclic carbonate compound in excess of 40:60 in the volume ratio of the cyclic carbonate compound and the linear carbonate compound, the obtained solution tends to be too viscous to permeate into the battery. It is difficult to keep satisfactory cycle retention under the influence of the high viscosity. The influence is remarkable in a battery of a high capacity or a high energy density such as a cylindrical battery or a square-shaped battery, particularly in a cylindrical or square-shaped battery having an electrode material layer of a high density in an electrode. When the electrolytic solution comprises the cyclic carbonate compound less than 20:80 in the volume ratio of the cyclic carbonate compound and the linear carbonate compound, the conductivity of the solution tends to be low and it is difficult to keep satisfactory cycle retention. Therefore, the volume ratio of the cyclic carbonate compound and the linear carbonate compound in the non-aqueous solvent preferably is in the range of 20:80 to 40:60, and more preferably in the range of 20:80 to 35:65.

The linear carbonate preferably has a methyl group to lower the viscosity. Accordingly, the linear carbonate preferably is dimethyl carbonate or methyl ethyl carbonate. Methyl ethyl carbonate, which has a low viscosity, a melting point of −20° C. or lower and a boiling point of 100° C. or higher, is a particularly preferred asymmetrical linear carbonate. The asymmetrical linear carbonate, namely methyl ethyl carbonate can be used in combination with a symmetrical linear carbonate, namely dimethyl carbonate and/or diethyl carbonate in a volume ratio of 100:0 to 51:49, and more preferably 100:0 to 70:30.

An excessive amount of the cyclic carbonate contained in the non-aqueous electrolytic solution might lower battery performances. On the other hand, when the amount of the compound is too small, satisfactory battery performances might not be provided. Therefore, the amount of the cyclic carbonate compound contained in the non-aqueous electrolytic solution preferably is 20 vol. % or more, and more preferably is 25 vol. % or more. Further, the amount preferably is 40 vol. % or less, and more preferably is 35 vol. % or less.

The cyclic carbonate compound having an unsaturated carbon-carbon bond such as vinylene carbonate, dimethylvinylene carbonate and vinylethylene carbonate is contained in the non-aqueous solvent in an amount of preferably 0.1 vol. % or more, more preferably 0.4 vol. % or more, and most preferably 0.8 vol. % or more. Further, the compound is contained in an amount of preferably 8 vol. % or less, more preferably 4 vol. % or less and most preferably 3 vol. % or less.

Other non-aqueous solvents can also be used in the present invention. Examples of the other solvents include lactones such as γ-butyrolactone (GBL), γ-valerolactone, and α-angelica lactone; ethers such as tetrahydrofuran, 2-methyltetrahydrofuran, 1,4-dioxane, 1,2-dimethoxyethane, 1,2-diethoxyethane, and 1,2-dibutoxyethane; nitriles such as acetonitrile, and adiponitrile; linear esters such as methyl propionate, methyl pivalate, butyl pivalate, hexyl pivalate, octyl pivalate, dimethyl oxalate, ethyl methyl oxalate, and diethyl oxalate; amides such as dimethylformamide; and compounds having an S═O bonding such as glycol sulfite, propylene sulfite, glycol sulfate, propylene sulfate, divinyl sulfone, 1,3-propane sultone, 1,4-butane sultone, and 1,4-butanediol dimethane sulfonate.

The non-aqueous solvents can be used in mixture. Examples of combinations of the non-aqueous solvents include a combination of a cyclic carbonate and a linear carbonate, a combination of a cyclic carbonate and a lactone, a combination of a cyclic carbonate, a lactone and a linear ester, a combination of a cyclic carbonate, a linear carbonate and a lactone, a combination of a cyclic carbonate, a linear carbonate and an ether, and a combination of a cyclic carbonate, a linear carbonate and a linear ester. Preferred are the combination of a cyclic carbonate and a linear carbonate, and the combination of a cyclic carbonate, a linear carbonate and a linear ester.

In the case that the cyclic carbonate compound is used in combination with a linear carbonate compound, the proportion of the cyclic carbonate compound and the linear carbonate compound in the non-aqueous solvent preferably is in the range of 20:80 to 40:60 in terms of a volume ratio. If the electrolytic solution comprises the cyclic carbonate compound in excess of 40:60 in the volume ratio of the cyclic carbonate compound and the linear carbonate compound, the obtained solution tends to be too viscous to permeate into the battery. It is difficult to keep satisfactory cycle retention under the influence of the high viscosity. The influence is remarkable in a battery of a high capacity or a high energy density such as a cylindrical battery or a square-shaped battery, particularly in a cylindrical or square-shaped battery having an electrode material layer of a high density in an electrode. If the electrolytic solution comprises the cyclic carbonate compound less than 20:80 in the volume ratio of the cyclic carbonate compound and the linear carbonate compound, the conductivity of the solution tends to be low and it is difficult to keep satisfactory cycle retention. Therefore, the volume ratio of the cyclic carbonate compound and the linear carbonate compound in the non-aqueous solvent preferably is in the range of 20:80 to 40:60, and more preferably in the range of 20:80 to 35:65.

The linear carbonate preferably has a methyl group to lower the viscosity. Accordingly, the linear carbonate preferably is dimethyl carbonate or methyl ethyl carbonate. Methyl ethyl carbonate, which has low viscosity, a melting point of −20° C. or lower and a boiling point of 100° C. or higher, is a particularly preferred asymmetrical linear carbonate. The asymmetrical linear carbonate, namely methyl ethyl carbonate can be used in combination with a symmetrical linear carbonate, namely dimethyl carbonate and/or diethyl carbonate in a volume ratio of 100:0 to 51:49, and more preferably 100:0 to 70:30.

Examples of electrolyte salts used in the non-aqueous electrolytic solution of the present invention include: LiPF₆, LiBF₄, LiClO₄; lithium salts comprising a chain alkyl group such as LiN(SO₂CF₃)₂, LiN(SO₂C₂F₅)₂, LiC(SO₂CF₃)₃, LiPF₄(CF₃)₂, LiPF₃(C₂F₅)₃, LiPF₃(CF₃)₃, LiPF₃(iso-C₃F₇)₃, and LiPF₅(iso-C₃F₇); and lithium salts comprising a cyclic alkylene group such as (CF₂)₂(SO₂)₂NLi, and (CF₂)₃(So₂)₂NLi. More preferred are LiPF₆, LiBF₄ and LiN(SO₂CF₃)₂, and most preferred is LiPF₆. The electrolyte salt can be used singly or in combination. Examples of the preferred combinations include a combination of LiPF₆ with Libe₄, a combination of LiPF₆ with LiN(SO₂CF₃)₂, and a combination of LiBF₄ with LiN(SO₂CF₃)₂. Most preferred is the combination of LiPF₆ with LiBF₄. There is no specific limitation with respect to the mixing ratio of the two or more electrolyte salts. In the case that LiPF₆ is mixed with other electrolyte salts, the amount of the other electrolyte salts preferably is 0.01 mole % or more, more preferably is 0.03 mole % or more, and most preferably is 0.05 mole % or more based on the total amount of the electrolyte salts. The amount of the other electrolyte salts also preferably is 45 mole % or less based on the total amount of the electrolyte salts, more preferably is 20 mole % or less, further preferably is 10 mole % or less, and most preferably is 5% mole t or less. The concentration of the electrolyte salts in the non-aqueous solvent preferably is 0.3 M or more, more preferably is 0.5 M or more, further preferably is 0.7 M or more, and most preferably is 0.8 M or more. Further, the concentration preferably is 2.5 M or less, more preferably is 2.0 M or less, further preferably is 1.6 M or less, and most preferably is 1.2 M or less.

The electrolytic solution of the invention can be obtained, for example by preparing a non-aqueous solvent containing the cyclic carbonate compounds, dissolving the electrolyte salts, and then dissolving the fluorobenzene compound and the cyclohexylbenzene compound having a halogenated benzene ring in the solvent.

The non-aqueous electrolytic solution of the invention has a dynamic viscosity at 25° C. preferably in the range of 2.3×10⁻⁶ to 3.6×10⁻⁶ m²/s, more preferably in the range of 2.3×10⁻⁶ to 3.2×10⁻⁶ m²/s, and most preferably in the range of 2.3×10⁻⁶ to 3.0×10⁻⁶ m²/s. The dynamic viscosity can be measured by a capillary measurement using a Cannon-Fenske viscometer.

The non-aqueous electrolytic solution of the invention can contain air or carbon dioxide to reduce gas generation caused by decomposition of the electrolytic solution and to improve battery performances such as cycle and storage characteristics.

Carbon dioxide or air can be incorporated (dissolved) into the non-aqueous electrolytic solution of the invention according to a method (1) of bringing the non-aqueous electrolytic solution into contact with air or a carbon dioxide-containing gas to introduce the air or gas into the solution, and then injecting the solution into a battery, or a method of (2) injecting the non-aqueous electrolytic solution into the battery, and then introducing air or a carbon dioxide-containing gas into a battery before or after sealing the battery. The two methods can be used in combination. The amount of the moisture contained in the air or carbon dioxide-containing gas preferably is as small as possible. The amount of the moisture is so reduced that the due point of the air or gas preferably is lower than −40° C., and more preferably lower than −50° C.

The non-aqueous electrolytic solution of the present invention is used for manufacturing a lithium secondary battery. There is no specific limitation with respect to materials of the lithium secondary battery other than the non-aqueous electrolytic solution of the present invention. The materials employed for the conventional lithium secondary battery can be used in the lithium secondary battery of the present invention.

The positive electrode active material preferably is a complex oxide of lithium with cobalt, manganese or nickel. The positive electrode active material can be used singly or in combination. Examples of the complex lithium oxide include LiCoO₂, LiMn₂O₄, LiNiO₂, LiCo₁₋ₓNiₓO₂ (0.01<x<1), LiCo_{1/3}Ni_{1/3}Mn_{1/3}O₂ and LiNi_{0.5}Mn_{1.5}O₄. The two or more positive electrode active materials can be mixed in an appropriate way. Examples of the mixtures include a mixture of LiCoO₂ with LiMn₂O₄, a mixture of LiCoO₂ with LiNiO₂, and a mixture of LiMn₂O₄ with LiNiO₂. The material more preferably is a complex lithium oxide that can be used at a terminal charging voltage of 4.3 V or more when the voltage is measured using lithium as reference. Examples of the complex lithium oxides that can be used at a voltage of 4.3 V or more include LiCoO₂, LiMn₂O₄ and LiNiO₂. The material further preferably is a complex lithium oxide that can be used at a terminal charging voltage of 4.4 V or more, such as LiCo_{1/3}Ni_{1/3}Mn_{1/3}O₂ and LiNi_{0.5}Mn_{1.5}O₄. A portion of a complex metal oxide of lithium can be replaced with another metal. For example, a portion of Co contained in LiCoO₂ can be replaced with Sn, Mg, Fe, Ti, Al, Zr, Cr, V, Ga, Zn or Cu.

A phosphoric salt of olivine type comprising lithium can also be used as the positive electrode active material. Examples of the phosphoric salts include LiFePO₄, LiCoPO₄, LiNiPO₄, LiMnPO₄, LiFe₁₋ₓMₓPO₄ (in which M is at least one of Co, Ni, Mn, Cu, Zn, and Cd, and x satisfies 0≦x≦0.5). Particularly preferred positive electrode active material for a high voltage is LiFePO₄ or LiCoPO₄, The phosphoric salt of olivine type can be mixed with another positive electrode active material.

A chemically inert electroconductive material can be used as a conductive material for the positive electrode. Examples of the conductive material include graphites such as natural graphite (e.g., scaly graphite), artificial graphite, and carbon blacks such as acetylene black, ketchen black, channel black, furnace black, lamp black, and thermal black. Graphite and carbon black can be used in combination at a certain mixing ratio. The positive electrode composite contains the conductive material preferably in an amount of 1 to 10 wt. %, and more preferably in an amount of 2 to 5 wt. %.

The positive electrode can be formed by mixing the positive electrode active material with the conductive material such as acetylene black or carbon black, and a binder to prepare a positive electrode composite material, coating a collecting sheet with the positive electrode material, and heating them at a temperature of about 50° C. to 250° C. for about 2 hours under reduced pressure. Examples of the binders include polytetrafluoroethylene (PTFE), polyvinylidene fluoride (PVDF), styrene/butadiene copolymer (SBR), acrylonitrile/butadiene copolymer (NBR), and carboxymethylcellulose (CMC). Examples of the collecting materials include aluminum foil and a stainless lath board.

A material capable of absorbing and releasing lithium can be used as the negative electrode (negative electrode active material). Examples of the material include: metallic lithium or lithium alloy; a carbonaceous material such as thermally decomposed carbon, coke, graphite (e.g., artificial graphite, natural graphite), a combustion product of an organic polymeric compound, or carbon fiber; tin or a tin compound; and silicon or a silicon compound. The carbonaceous material preferably has a distance (d₀₀₂) between lattice faces (002) of 0.340 nm or less. The carbonaceous material more preferably is graphite having a graphitic crystal structure with the distance (d₀₀₂) in the range of 0.335 to 0.340 nm.

The negative electrode active material can be used singly or in combination. A powdery material such as a powder of carbonaceous material can be used as a negative electrode composite material by mixing the material with a binder. Examples of the binders include ethylene/propylene diene terpolymer (EPDM), polytetrafluoroethylene (PTFE), polyvinylidene fluoride (PVDF), styrene/butadiene copolymer (SBR), acrylonitrile/butadiene copolymer (NBR), and carboxymethyl-cellulose (CMC). There is no specific limitation with respect to the method for forming the negative electrode. The negative electrode can be prepared in the same manner as in the above-mentioned method for forming the positive electrode.

There is no specific limitation with respect to the structure of the lithium secondary battery. Examples of the structures include a coin-shaped battery, a cylindrical battery, and a square-shaped battery. The coin-shaped battery comprises a positive electrode, a negative electrode, and a single-layered or a multi-layered separator. The cylindrical or square-shaped battery comprises a positive electrode, a negative electrode and a rolled separator. A known separator such as a microporous material of polyolefin, a fabric, and a non-woven fabric can be used. The separator for the battery can be a single layered porous film or a multi-layered porous film.

The separator for the battery has a gas permeability preferably in the range of 50 to 1,000 seconds per 100 cc, more preferably in the range of 100 to 800 seconds per 100 cc, and most preferably in the range of 300 to 500 seconds per 100 cc depending on the manufacturing conditions. In the case that the gas permeability is extremely high, the conductivity of lithium ion lowers to cause unsatisfactory function as battery separator. In the case that the gas permeability is extremely low, the mechanical strength lowers. The void volume ratio preferably is in the range of 30 to 60%, more preferably is in the range of 35 to 55%, and most preferably is in the range of 40 to 50%. The void ratio is so adjusted as to improve the battery capacity. The thickness of the separator for the battery is preferably thin to increase the energy density. In consideration of both the mechanical strength and the performance increases, the thickness of the separator preferably is small. The thickness of the separator preferably is in the range of 5 to 50 μm, more preferably in the range of 10 to 40 μm, and most preferably in the range of 15 to 25 μm.

A favorable effect of an additive provided in the present invention depends on density of an electrode material layer in a lithium secondary battery. The positive electrode composite layer formed on aluminum foil has a density of preferably in the range of 3.2 to 4.0 g/cm³, more preferably in the range of 3.3 to 3.9 g/cm³, and most preferably in the range of 3.4 to 3.8 g/cm³. The negative electrode composite layer formed on copper foil has a density of preferably in the range of 1.3 to 2.0 g/cm³, more preferably in the range of 1.4 to 1.9 g/cm³, and most preferably in the range of 1.5 to 1.8 g/cm³.

In the present invention, the positive electrode layer can have a thickness (layer on each side of the collector) in the range of 30 to 120 μm, and more preferably in the range of 50 to 100 μm. The negative electrode layer (layer on each side of the collector) has a thickness preferably in the range of 1 to 100 μm, and more preferably in the range of 3 to 70 μm.

There is no specific limitation with respect to the structures of the lithium secondary battery. Examples of the structure include a coin-shaped battery, a cylindrical battery, a square-shaped battery, and a lamination battery. The battery comprises a positive electrode, a negative electrode, a porous separator and a non-aqueous electrolytic solution. The cylindrical or square-shaped battery is preferred.

The lithium secondary battery of the present invention shows excellent cycle characteristics for a long term even in the case where the charging termination voltage is higher than 4.2 V. The battery can further show excellent cycle characteristics even in the case where the charging termination voltage is 4.3 V or more. The discharging termination voltage can be 2.5 V or more, and further can be 2.8 V or more. There is no specific limitation with respect to the current level. The battery is generally discharged at a constant current of 0.1 to 3 C. The lithium secondary battery of the present invention can be charged and discharged at a temperature of −40° C. or higher, and preferably at 0° C. or higher. Further, the battery can be charged and discharged at a temperature of 100° C. or lower, and preferably 80° C. or lower.

A safety valve can be attached to a sealing plate to keep the lithium secondary battery of the invention from increasing the inner pressure. A part of the battery such as a battery cell (can) or a gasket can have a cut to avoid pressure increase. At least one of various conventional safety attachments (for example, overcurrent-preventing devices such as a fuse, a bimetal and a PTC device) is preferably attached to the battery.

Two or more lithium secondary batteries of the invention can be placed in a battery package in series and/or parallel. A safety circuit (which has functions of monitoring conditions such as voltage, temperature and current in each of the battery and/or in the combined batteries, and breaking the current) can be attached to the battery package in addition to a safety attachment such as a PTC element, a thermal fuse, a fuse, and/or a current breaker.

The battery of the present invention can be used in various devices such as a mobile phone, a notebook computer, PDA, a camcorder, a compact camera, a shaver, an electric machinery tool, and an automobile. The lithium secondary battery of the invention is highly reliable, and is advantageously used in devices requiring a charging current of 0.5 A or higher.

### EXAMPLES

The present invention is described by referring to the following examples and comparison examples.

### Example 1

(Preparation of Non-Aqueous Electrolytic Solution)

A non-aqueous solvent of EC:VC:MEC (volume ratio=28:2:70) was prepared. LiPF₆ was dissolved in the solvent to prepare a 1 M non-aqueous electrolytic solution. 1 wt. % (based on the non-aqueous electrolytic solution) of 2,4-difluoroanisole and 2 wt. % (based on the non-aqueous electrolytic solution) of 1-fluoro-4-cyclohexylbenzene were added to the non-aqueous electrolytic solution. The dynamic viscosity of the electrolytic solution was 2.7×10⁻⁶ m²/s at 25° C.

(Preparation of Lithium Secondary Battery and Measurement of Battery Performance)

90 wt. % of LiCoO₂ (positive electrode active material), 5 wt. % of acetylene black (conductive material), and 5 wt. % of polyvinylidene fluoride (binder) were mixed. 1-methyl-2-pyrrolidone was added to the mixture to give a slurry. A surface of aluminum foil was coated with the slurry. The coated foil was dried, and molded under pressure to form a positive electrode.

95 wt. % of artificial graphite (negative electrode active material) having a graphitic crystalline structure with a distance (d₀₀₂) of 0.335 nm between lattice faces (002), and 5 wt. % of polyvinylidene fluoride (binder) were mixed. 1-methyl-2-pyrrolidone was added to the mixture to give a slurry. A surface of copper foil was coated with the slurry. The coated foil was dried, and molded under pressure to form a negative electrode.

A battery was prepared using a separator comprising a microporous polypropylene film (thickness: 20 μm). The non-aqueous electrolytic solution was poured into the battery, Before sealing the battery, carbon dioxide having the dew point of −60° C. was introduced into the battery to prepare a cylindrical battery having the 18650 size (diameter: 18 mm, height: 65 mm). A pressure release vent and an inner current breaker (PTC element) were attached to the battery. The positive electrode had a density of 3.5 g/cm³, and the negative electrode had a density of 1.6 g/cm³. The positive electrode layer had a thickness of 70 μm (layer on each side of the collector), and the negative electrode layer had a thickness of 60 μm (layer on each side of the collector).

In a cycle test, the battery was charged with the constant current of 2.2 A (1C) at an elevated temperature (45° C.) to reach 4.3 V. The battery was further charged under the constant voltage for 3 hours in total to reach the terminal voltage of 4.3 V. The battery was discharged under the constant current of 2.2 A (1C) to reach the terminal voltage of 3.0 V. The charge and the discharge were repeated. The initial discharging capacity was identical with the result of the case (Comparison example 2) that 3 wt. % of 2,4-difluoroanisole was added to the non-aqueous electrolytic solution in place of 1-fluoro-4-cyclohexylbenzene to prepare an electrolytic solution of 1 M LiPF₆-EC/VC/MEC (volume ratio=28/2/70). The battery performance was measured after 200 cycles, and the retention of the discharging capacity relative to the initial discharging capacity (100%) was 80.8%. Further, the amount of the generated gas after 200 cycles was remarkably smaller than that in the case of Comparison example 2.

After the cycle of charge and discharge was repeated five times, the battery was fully charged to reach 4.2 V at an ordinary temperature (20° C.), and further charged with the constant current of 2.2A (1C) to conduct an overcharge test. The temperature on the surface of the battery was not higher than 120° C., which is the standard highest temperature for safety. The conditions for preparation of the battery and the battery performance thereof. are set forth in Table 1.

### Example 2

A 18650 battery was prepared in the same manner as in Example 1, except that 1 wt. % (based on the non-aqueous electrolytic solution) of fluorobenzene was used in place of 2,4-difluoroanisole. The battery performance was measured after 200 cycles, and the retention of the discharging capacity relative to the initial discharging capacity (100%) was 82.1%. The temperature on the surface of the battery was not higher than 120° C. in overcharge test. The conditions for preparation of the battery and the battery performance thereof are set forth in Table 1. The dynamic viscosity of the electrolytic solution was 2.7×10⁻⁶ m²/s at 25° C.

### Example 3

A non-aqueous solvent of EC:VC:MEC:PS (1,3-propanesultone) (volume ratio=28:2:69:1) was prepared. LiPF₆ was dissolved in the solvent to prepare a 1 M non-aqueous electrolytic solution. 1 wt. % (based on the non-aqueous electrolytic solution) of fluorobenzene and 2 wt. % (based on the non-aqueous electrolytic solution) of 1-fluoro-4-cyclohexylbenzene were added to the non-aqueous electrolytic solution.

An 18650 battery was prepared in the same manner as in Example 1, except that the prepared electrolytic solution was used. The battery performance was measured after 200 cycles, and the retention of the discharging capacity relative to the initial discharging capacity (100%) was 82.4%. The temperature on the surface of the battery was not higher than 120° C. in overcharge test. The conditions for preparation of the battery and the battery performance thereof are set forth in Table 1. The dynamic viscosity of the electrolytic solution was 2.7×10⁻⁶ m²/s at 25° C.

### Example 4

A non-aqueous solvent of EC:VC:MEC:EMO (ethyl methyl oxalate) (volume ratio=28:2:69:1) was prepared. LiPF₆ was dissolved in the solvent to prepare a 1 M non-aqueous electrolytic solution. 1 wt. % (based on the non-aqueous electrolytic solution) of fluorobenzene and 2 wt. % (based on the non-aqueous electrolytic solution) of 1-fluoro-4-cyclohexylbenzene were added to the non-aqueous electrolytic solution.

An 18650 battery was prepared in the same manner as in Example 1, except that the prepared electrolytic solution was used. The battery performance was measured after 200 cycles, and the retention of the discharging capacity relative to the initial discharging capacity (100%) was 82.5%. The temperature on the surface of the battery was not higher than 120° C. in overcharge test. The conditions for preparation of the battery and the battery performance thereof are set forth in Table 1. The dynamic viscosity of the electrolytic solution was 2.7×10⁻⁶ m²/s at 25° C.

### Comparison Example 1

A non-aqueous solvent of EC:VC:MEC (volume ratio=28:2:70) was prepared. LiPF₆ was dissolved in the solvent to prepare a 1 M non-aqueous electrolytic solution. 3 wt. % (based on the non-aqueous electrolytic solution) of fluorobenzene was added to the non-aqueous electrolytic solution.

An 18650 battery was prepared in the same manner as in Example 1, except that the prepared electrolytic solution was used. The battery performance was measured after 200 cycles, and the retention of the discharging capacity relative to the initial discharging capacity (100%) was 78.5%. The temperature on the surface of the battery was higher than 120° C. in overcharge test, which means that the effect of protection from overcharge was not observed. The conditions for preparation of the battery and the battery performance thereof are set forth in Table 1. The dynamic viscosity of the electrolytic solution was 2.7×10⁻⁶ m²/s at 25° C.

### Comparison Example 2

A non-aqueous solvent of EC:VC:MEC (volume ratio=28:2;70) was prepared. LiPF₆ was dissolved in the solvent to prepare a 1 M non-aqueous electrolytic solution. 3 wt % (based on the non-aqueous electrolytic solution) of 2,4-difluoroanisole was added to the non-aqueous electrolytic solution.

An 18650 battery was prepared in the same manner as in Example 1, except that the prepared electrolytic solution was used. The battery performance was measured after 200 cycles, and the retention of the discharging capacity relative to the initial discharging capacity (100%) was 75.2%. The temperature on the surface of the battery was not higher than 120° C. in overcharge test. The conditions for preparation of the battery and the battery performance hereof are set forth in Table 1. The dynamic viscosity of the electrolytic solution was 2.7×10⁻⁶ m²/s at 25° C.

### Comparison Example 3

A non-aqueous solvent of EC:VC:DEC (volume ratio=41:2:57) was prepared. The weight ratio of the cyclic carbonate compound and the linear carbonate compound was 1:1. LiPF₆ was dissolved in the solvent to prepare a 1 M non-aqueous electrolytic solution. 3 wt. % (based on the non-aqueous electrolytic solution) of 1-fluoro-4-cyclohexylbenzene was added to the non-aqueous electrolytic solution.

An 18650 battery was prepared in the same manner as in Example 1, except that the prepared electrolytic solution was used. The battery performance was measured after 200 cycles, and the retention of the discharging capacity relative to the initial discharging capacity (100%) was 76.6%. The temperature on the surface of the battery was not higher than 120° C. in overcharge test. The conditions for preparation of the battery and the battery performance thereof are set forth in Table 1. The dynamic viscosity of the electrolytic solution was 3.7×10⁻⁶ m2/s at 25° C.

TABLE 1

| | Positive | Negative | Composition of electrolytic |
|---|---|---|---|
| | electrode | electrode | solution (volume ratio) |
| Example 1 | LiCoO₂ | Artificial | 1M LiPF₆ |
| | | graphite | EC/VC/MEC = 28/2/70 |
| Example 2 | LiCoO₂ | Artificial | 1M LiPF₆ |
| | | graphite | EC/VC/MEC = 28/2/70 |
| Example 3 | LiCoO₂ | Artificial | 1M LiPF₆ |
| | | graphite | EC/VC/MEC/PS = 28/2/69/1 |
| Example 4 | LiCoO₂ | Artificial | 1M LiPF₆ |
| | | graphite | EC/VC/MEC/EMO = 28/2/69/1 |
| Comparison | LiCoO₂ | Artificial | 1M LiPF₆ |
| Example 1 | | graphite | EC/VC/MEC = 28/2/70 |
| Comparison | LiCoO₂ | Artificial | 1M LiPF₆ |
| Example 2 | | graphite | EC/VC/MEC = 28/2/70 |
| Comparison | LiCoO₂ | Artificial | 1M LiPF₆ |
| Example 3 | | graphite | EC/VC/DEC = 41/2/57 |

| | | Cyclohexyl- | Retention | Effect |
|---|---|---|---|---|
| | | benzene com- | of dis- | of pro- |
| | Fluorobenzene | pound having | charging | tection |
| | compound | halogenated | capacity | from |
| | (amount: | benzene ring | (%) after | over- |
| | wt. %) | (amount: wt. %) | 200 cycles | charge |
| Example 1 | 2,4-Difluoro- | 1-Fluoro-4- | 80.8 | Observed |
| | anisole (1) | cyclohexyl- | | |
| | | benzene (2) | | |
| Example 2 | Fluorobenzene | 1-Fluoro-4- | 82.1 | Observed |
| | (1) | cyclohexyl- | | |
| | | benzene (2) | | |
| Example 3 | Fluorobenzene | 1-Fluoro-4- | 82.4 | Observed |
| | (1) | cyclohexyl- | | |
| | | benzene (2) | | |
| Example 4 | Fluorobenzene | 1-Fluoro-4- | 82.5 | Observed |
| | (1) | cyclohexyl- | | |
| | | benzene (2) | | |
| Comparison | Fluorobenzene | None | 78.5 | Not |
| Example 1 | (3) | | | observed |
| Comparison | 2,4-Difluoro- | None | 75.2 | Observed |
| Example 2 | anisole (3) | | | |
| Comparison | None | 1-Fluoro-4- | 76.6 | Observed |
| Example 3 | | cyclohexyl- | | |
| | | benzene (3) | | |

The present invention is not limited to the examples described above. The various combinations can be possible according to the invention. Particularly, the combinations of solvents cannot be limited to the examples. Further, the present invention can be applied to a square-shaped battery, a coin-shaped battery or a laminated battery, though the Examples relate to a cylindrical battery.

1. A non-aqueous electrolytic solution for a lithium secondary battery comprising an electrolyte salt in a non-aqueous solvent, wherein the non-aqueous solvent comprises two or more cyclic carbonate compounds, and wherein the non-aqueous electrolytic solution further contains 1 to 10 wt. % of a cyclohexylbenzene compound having a halogenated benzene ring and 0.1 to 5 wt. % of a fluorobenzene compound.

2. The non-aqueous electrolytic solution of claim 1, wherein the two or more cyclic carbonate compounds comprise a compound selected from the group consisting of ethylene carbonate, propylene carbonate and butylene carbonate, and a compound selected from the group consisting of vinylene carbonate, dimethylvinylene carbonate, vinylethylene carbonate and fluoroethylene carbonate.

3. The non-aqueous electrolytic solution of claim 1, wherein the non-aqueous solvent further comprises a linear carbonate compound.

4. The non-aqueous electrolytic solution of claim 3, wherein a volume ratio of the cyclic carbonate compounds and the linear carbonate compound is in the range of 20:80 to 40:60

5. The non-aqueous electrolytic solution of claim 3, wherein the linear carbonate compound comprises methyl ethyl carbonate.

6. The non-aqueous electrolytic solution of claim 1, wherein the cyclohexylbenzene compound having a halo-genated benzene ring is 1-fluoro-2-cyclohexylbenzene, 1-fluoro-3-cyclohexylbenzene, 1-fluoro-4-cyclohexylbenzene, 1-chloro-4-cyclohexylbenzene, 1-brono-4-cyclohexylbenzene, 1-iodo-4-cyclohexylbenzene, 1,2-dichloro-3-cyclohexylbenzene, 1,3-dibromo-4-cyclohexylbenzene, 1,4-dichloro-2-cyclohexylbenzene, 1,2-difluoro-4-cyclohexylbenzene, or 1,3-difluoro-5-cyclohexylbenzene.

7. The non-aqueous electrolytic solution of claim 1, wherein the fluorobenzene compound is fluorobenzene, difluorobenzene, trifluorobenzene, 2,4-difluoroanisole, 2,5-difluoroanisole, or 2,6-difluoroanisole.

8. A lithium secondary battery comprising a positive electrode, a negative electrode and a non-aqueous electrolytic solution comprising an electrolyte salt in a non-aqueous solvent, wherein the non-aqueous solvent comprises two or more cyclic carbonate compounds, and wherein the non-aqueous electrolytic solution further contains 1 to 10 wt. % of a cyclohexylbenzene compound having a halogenated benzene ringand 0.1 to 5 wt. % of a fluorobenzene compound.

9. The lithium secondary battery of claim 8, wherein the two or more cyclic carbonate compounds comprise a compound selected from the group consisting of ethylene carbonate, propylene carbonate and butylene carbonate, and a compound selected from the group consisting of vinylene carbonate, dimethylvinylene carbonate, vinylethylene carbonate and fluoroethylene carbonate.

10. The lithium secondary battery of claim 8, wherein the non-aqueous solvent further comprises a linear carbonate compound.

11. A process of working a lithium secondary battery comprising a positive electrode, a negative electrode and a non-aqueous electrolytic solution comprising an electrolyte salt in a non-aqueous solvent at a maximum working voltage of higher than 4.2 V, wherein the non-aqueous solvent comprises two or more cyclic carbonate compounds, and wherein the non-aqueous electrolytic solution further contains 1 to 10 wt. % of a cyclohexylbenzene compound having a halogenated benzene ring and 0.1 to 5 wt. % of a fluorobenzene compound.
